(19) United States
(12) Patent Application Publication
(10) Pub. No.: US 2016/0217678 A1
(43) Pub. Date: Jul. 28, 2016

(54) Personal Security Assembly

(71) Applicant: Ziyad Hassan, Spring, TX (US)

(72) Inventor: Ziyad Hassan, Spring, TX (US)

(21) Appl. No.: 14/603,581

(22) Filed: Jan. 23, 2015

(51) Int. Cl. G08B 25/01; G08B 25/10

(52) U.S. Cl. CPC G08B 25/016; G08B 25/10

(57) ABSTRACT

A personal security assembly for discretely contacting law enforcement includes a ring configured to be worn. The ring has an outer surface, an inner surface and a peripheral edge extending therebetween and the outer surface has a flat section. An alarm is positioned within the ring and is in wireless communication with an external communications network. The alarm is actuated in an emergency wherein the alarm contacts law enforcement through the external communications network.

### BACKGROUND OF THE DISCLOSURE

### Field of the Disclosure

The disclosure relates to security devices and more particularly pertains to a new security devivce for discretely contacting law enforcement.

### SUMMARY OF THE DISCLOSURE

An embodiment of the disclosure meets the needs presented above by generally comprising a ring configured to be worn. The ring has an outer surface, an inner surface and a peripheral edge extending therebetween and the outer surface has a flat section. An alarm is positioned within the ring and is in wireless communication with an external communications network. The alarm is actuated in an emergency wherein the alarm contacts law enforcement through the external communications network.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a personal security assembly according to an embodiment of the disclosure.

FIG. 2 is a bottom perspective view of an embodiment of the disclosure.

FIG. 3 is a back perspective view of an embodiment of the disclosure.

FIG. 4 is a front view of an embodiment of the disclosure.

FIG. 5 is a schematic view of an embodiment of the disclosure.

### DESCRIPTION OF THE PREFERRED EMBODIMENT

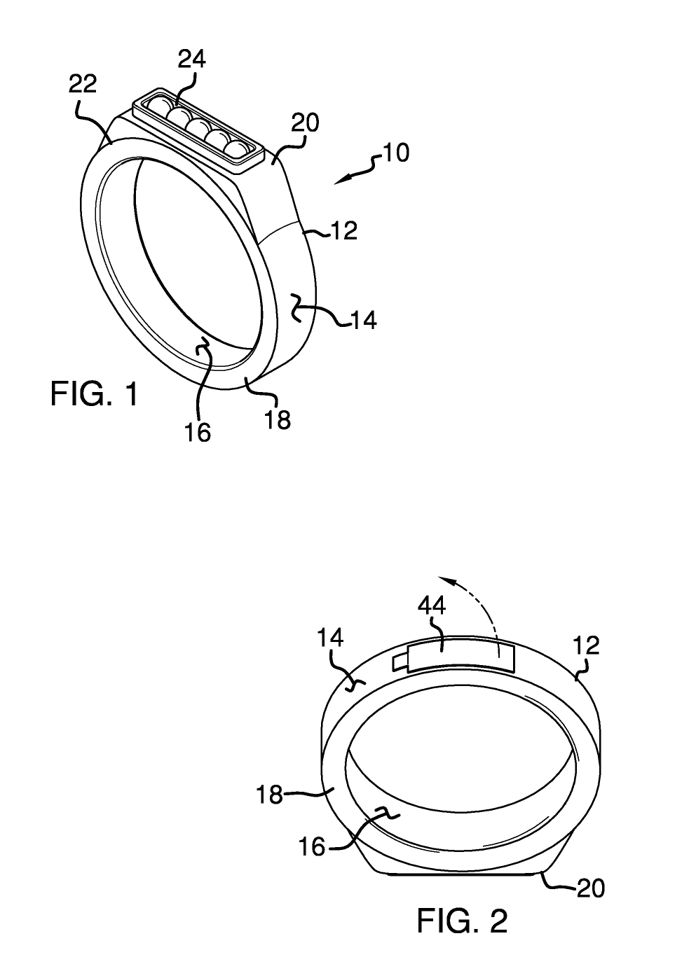

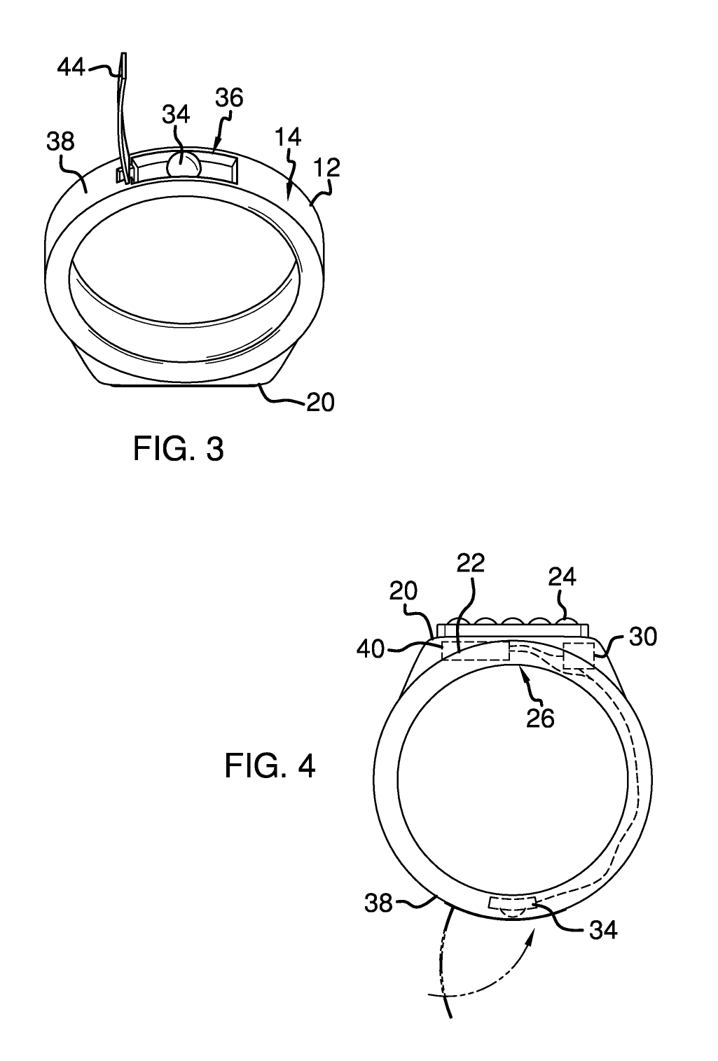

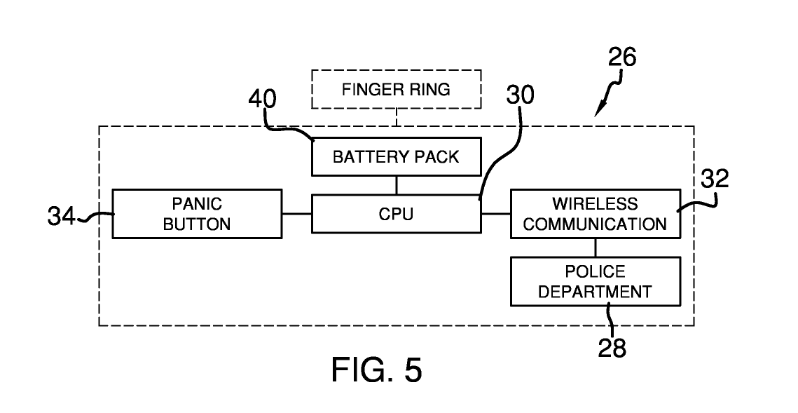

With reference now to the drawings, and in particular to FIGS. 1 through 5 thereof, a new security devivce embodying the principles and concepts of an embodiment of the disclosure and generally designated by the reference numeral 10 will be described.

As best illustrated in FIGS. 1 through 5, the personal security assembly 10 generally comprises a ring 12 that may be worn. The ring 12 has an outer surface 14, an inner surface 16 and a peripheral edge 18 extending therebetween. The outer surface 14 has a flat section 20 and the flat section 20 is positioned on a top side 22 of the ring 12. Decorations 24 may be coupled to the outer surface 14. The decorations 24 may be positioned on the flat section 20.

An alarm 26 is positioned within the ring 12 and is in wireless communication with an external communications network 28. The alarm 26 is actuated in an emergency to contact law enforcement through the external communications network 28. The external communications network 28 may comprise a cellular phone network, the internet or a hard wired telephone network.

The alarm 26 comprises a control circuit 30 positioned within the ring 12. A transmitter 32 is positioned within the ring 12 and is electrically coupled to the control circuit 30. The transmitter 32 is in wireless communication with the external communications network 28. The transmitter 32 may be a radio frequency transmitter or the like that has GPS capabilities. The transmitter 32 may transmit a location of the ring 12 to law enforcement, allowing the ring 12 to be tracked.

An actuator 34 is positioned within the ring 12 and is electrically coupled to the control circuit 30. The transmitter 32 contacts law enforcement through the external communications network 28 when the actuator 34 is engaged. The outer surface 14 has a well 36 extending inwardly therein. The well 36 is positioned on a bottom side 38 of the ring 12 and the actuator 34 is positioned within the well 36.

A power supply 40 is positioned within the ring 12 and is electrically coupled to the control circuit 30. The power supply 40 comprises at least one battery 42. A door 44 is provided that is hingedly coupled to the ring 12. The door 44 is positioned on the outer surface 14 to selectively cover the well 36.

In use, the ring 12 is worn in the convention of jewelry. The door 44 is opened and the actuator 34 is engaged in the event of an emergency. The emergency may be a theft, an assault or witnessing a similar act is committed. The actuator 34 discretely contacts law enforcement and the transmitter 32 provides a location of the emergency to law enforcement. The ring 12 provides the ability to contact law enforcement without notifying observers or other individuals that law enforcement has been contacted.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A personal security assembly configured to provide a discrete means of contacting law enforcement, said assembly comprising:
a ring configured to be worn, said ring having an outer surface, an inner surface and a peripheral edge extending therebetween, said outer surface having a flat section; and
a alarm positioned within said ring, said alarm is in configured to be in wireless communication with an external communications network, said alarm is actuated in an emergency wherein said alarm contacts law enforcement through the external communications network.

2. The assembly according to claim 1, wherein said alarm comprises a control circuit positioned within said ring.

3. The assembly according to claim 2, further comprising a transmitter positioned within said ring, said transmitter is electrically coupled to said control circuit, said transmitter is configured to be in wireless communication with the external communications network.

4. The assembly according to claim 3, further comprising an actuator positioned within said ring, said actuator is electrically coupled to said control circuit, said transmitter contacting law enforcement through the external communications network when said actuator is engaged.

5. The assembly according to claim 4, further comprising a power supply positioned within said ring, said power supply is electrically coupled to said control circuit, said power supply comprising at least one battery.

6. The assembly according to claim 5, further comprising a door hingedly coupled to said ring, said door is positioned on said outer surface to conceal said actautor.

7. A personal security assembly configured to provide a discrete means of contacting law enforcement, said assembly comprising:
a ring configured to be worn, said ring having an outer surface, an inner surface and a peripheral edge extending therebetween, said outer surface having a flat section;
a alarm positioned within said ring, said alarm is in configured to be in wireless communication with an external communications network, said alarm is actuated in an emergency wherein said alarm contacts law enforcement through the external communications network, said alarm comprising:
a control circuit positioned within said ring;
a transmitter positioned within said ring, said transmitter is electrically coupled to said control circuit, said transmitter is configured to be in wireless communication with the external communications network;
an actuator positioned within said ring, said actuator is electrically coupled to said control circuit, said transmitter contacting law enforcement through the external communications network when said actuator is engaged; and
a power supply positioned within said ring, said power supply is electrically coupled to said control circuit, said power supply comprising at least one battery; and
a door hingedly coupled to said ring, said door is positioned on said outer surface to conceal said actautor.
